(19) United States
(12) Patent Application Publication
(10) Pub. No.: US 2023/0228195 A1
(43) Pub. Date: Jul. 20, 2023

(54) Wankel pump cycle residual boost system

(71) Applicants: Hung-Chih Huang, Taichung (TW); Huang-Ming Liu, Tainan (TW)

(72) Inventors: Hung-Chih Huang, Taichung (TW); Huang-Ming Liu, Tainan (TW)

(21) Appl. No.: 18/123,945

(22) Filed: Mar. 20, 2023

(51) Int. Cl. F01C 21/10; F16J 15/16

(52) U.S. Cl. CPC F01C 21/10; F16J 15/164; F01C 2021/165

(57) ABSTRACT

A cycle residual boost and two release cavities are provided on a cylinder wall. Wankel cycle air pump is provided with additional cavities which allow the pressure output higher than its fixed compression ratio and further increase compression efficiency. An apex seal active tracking mechanism is also provided. Wankel cycle air pump rotor plates passage makes apex seals keep firmly contact against a cylinder.

### CROSS-REFERENCE TO RELATED APPLICATIONS

This application is a continuation-in-part (CIP) of U.S. patent application Ser. No. 17/664,430, filed May 23, 2022. The contents of the above application are all incorporated herein by reference.

### FIELD OF THE INVENTION

The invention relates to Wankel cycle air compressors, in which by means of creating cavities on cylinder wall at particular rotor angles, those cavities provide cycle residual compressed air a passage to escape into next compressing cycle. Further, gate way open and close are related to rotor rotation angles, which are controlled by rotor apex seal movement.

### BACKGROUND OF THE INVENTION

Inspired by Wankel cycle engine, in a conventional Wankel cycle configuration, the compression ratio is limited in comparison with piston configuration. By using cycle residual cavities, it is able to further increase the pressure output as well as improve energy efficiency for air compressor.

Cavities on cylinder wall are defined in 2 groups. Group A is for cycle compressed residual air and an escape gate way to next compression chamber. Group B is for second release to incoming intake stroke.

While residual compressed air not fully discharged by group A cavities, the second release cavities of group B allow sub-pressure air in another gate to discharge into incoming intake stroke. While the second discharging, rotor tip expands space to accommodate extra incoming air.

All these measurements are to ensure air can be fully sucked in rather than being pushed out while intake port is open no matter how high the output pressure is.

In order to achieve precise control of ports open and close, 2 rotor side plates are used, rotor plates are held in place by 3 apex seals against main rotor. Side rings and corner seals are retained in between of main rotor and rotor plates.

Rotor plates are free to adjust clearances against cylinder side wall, by opening a passage on rotor plate tips which allow the apex to seal 2 terminal ends which always stay at relative low pressure against apex seal bottom chamber pressure. Apex seal bottom pressure is a necessary force to push apex seal against cylinder wall.

With pressure difference of apex seal bottom pressure between apex terminal ends pressure, this pressure difference forces apex seal wedges to push outward against apex seal terminal ends and eventually the force is turned into a force to push apex seal against cylinder wall.

### SUMMARY OF THE INVENTION

The invention is capable to allow compressor output air pressure far beyond its fixed compression ratio by recycling energies that was once wasted.

For reciprocating compressor, there is always a need of a safe space to compensate material heat expansion and avoid components impact damage so does Wankel compressor. Every cycle compression always generates residual compressed air in this safe space. The residual compressed air has become an issue while the cycle transfers from compression to intake stroke and expanding residual air obstructs new air from coming in. As a result, the output efficiency drops dramatically while compressor is at the output pressure equal to compression ratio pressure.

To overcome this issue, cycle residual boost cavities on cylinder wall are created. Conventional Wankel configuration makes the side ring contacted with side wall, while ring travels through port, compressed air is leaking out from main rotor as main rotor itself does not work as a seal.

Rotor side plates are designed for two purposes:

The first one is to precisely control intake and outlet ports open and close.

The second one is to create a low pressure passage from crank case to apex seal terminal ends, by using pressure differences to force apex seal to keep firmly contact with cylinder wall.

The above and other objects, features and advantages of the invention will become apparent from the following detailed description taken with the accompanying drawings.

### BRIEF DESCRIPTION OF THE DRAWINGS

FIG. 1 schematically depicts a Wankel cycle air compressor of the invention;

FIG. 2 is a timing chart of compressor operations at crank angles −9, 0, 9, 18, and 27 degrees;

FIG. 3 is a perspective view showing positions of cavities in a cylinder; and

FIG. 4 is an exploded view showing a configuration of a main rotor.

### DETAILED DESCRIPTION OF THE INVENTION

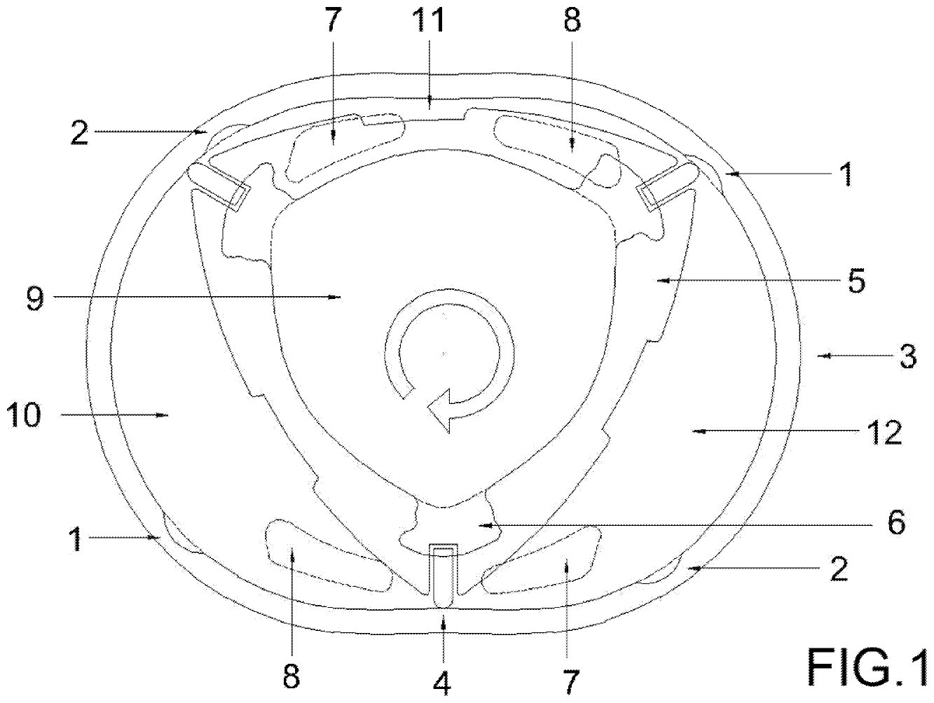

Referring to FIGS. 1 to 4, a Wankel cycle air compressor in accordance with the invention is shown. Operations of the Wakel cycle air compressor are discussed below.

A cylinder 3 has a cylinder wall 9. A main rotor 15 rotates inside the cylinder 3 and separates the cylinder 3 into a first chamber 10, a second chamber 11 and a third chamber 12. Each of the chambers 10, 11 and 12 increase and decrease volume according to a crank shaft angle. The first chamber 10 having an increased volume chamber sucks air while an intake port 8 is open. In the meantime, the second and third chambers 11 and 12 having a decreased volume pump air through an outlet port 7. The first, second and third chambers 10, 11 and 12 alternatively execute sucking and pumping while a crank shaft is rotating.

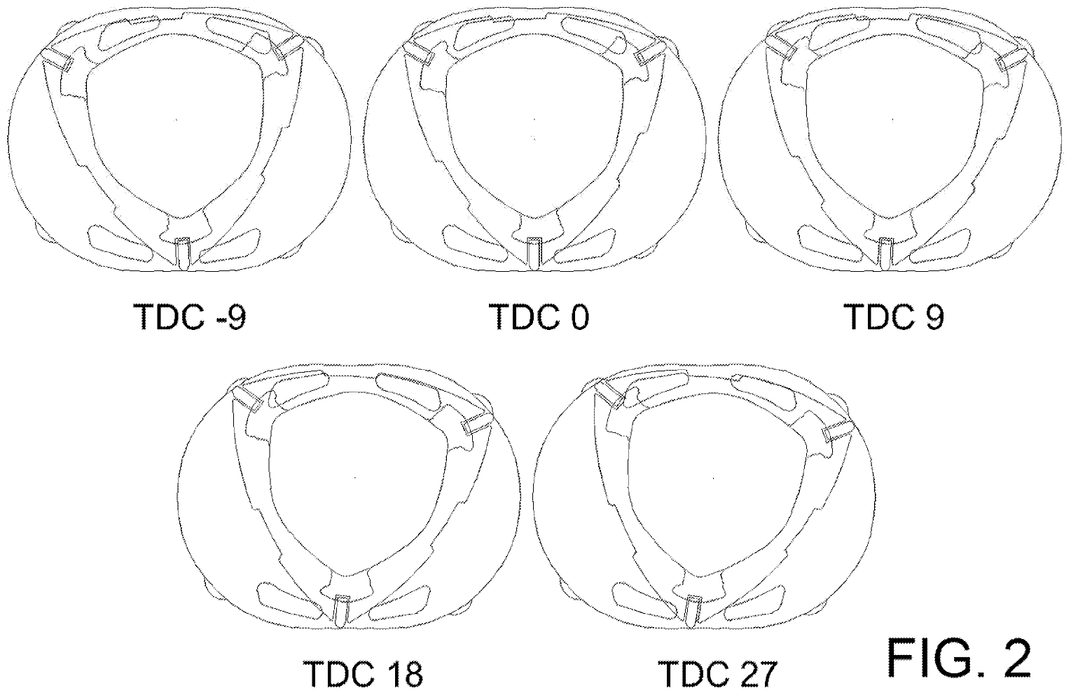

As shown in FIG. 2 specifically, it is a timing chart of compression operations at crank angles −9, 0, 9, 18, and 27 degrees.

In detail, FIG. 2 shows the operation of TDC −9 degrees. Compression stroke of the second chamber 11 comes to an end. At this angle, volume reaches a minimum and no more air can be pumped out.

At TDC 0 degree, residual air escapes to the second chamber 12 for compression through a boost cavity 1 which further increases pressure of the second chamber 12 for compression.

At TDC 9 degrees, the boost cavity 1 is going to close and a second release cavity 2 is going to open.

At TDC 18 degrees, air having a lower pressure is released to the first chamber 10 through the second release cavity 2.

At TDC 27 degrees, the second release cavity 2 is going to close.

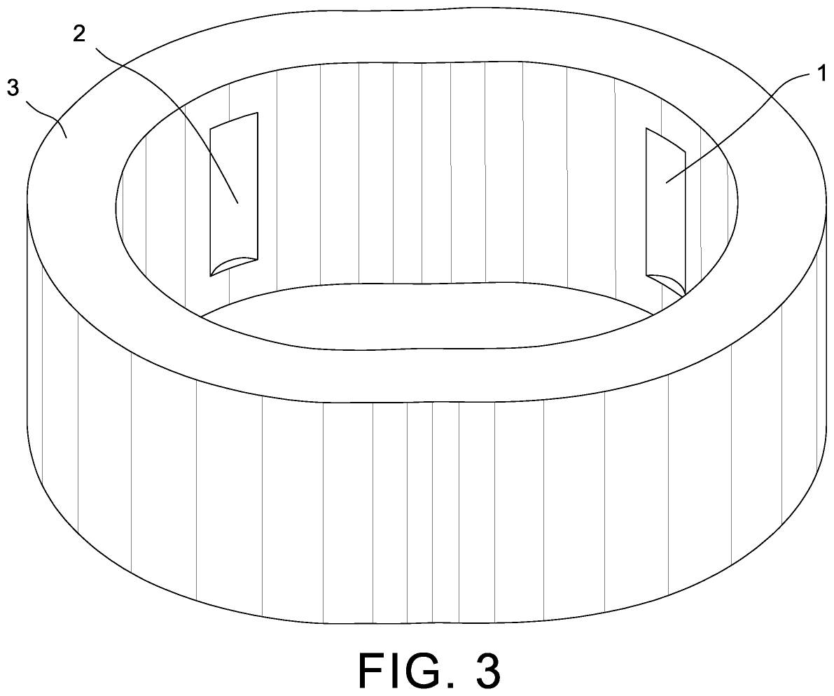

As shown in FIG. 3 specifically, it shows the cavities 1 and 2 in the cylinder 3.

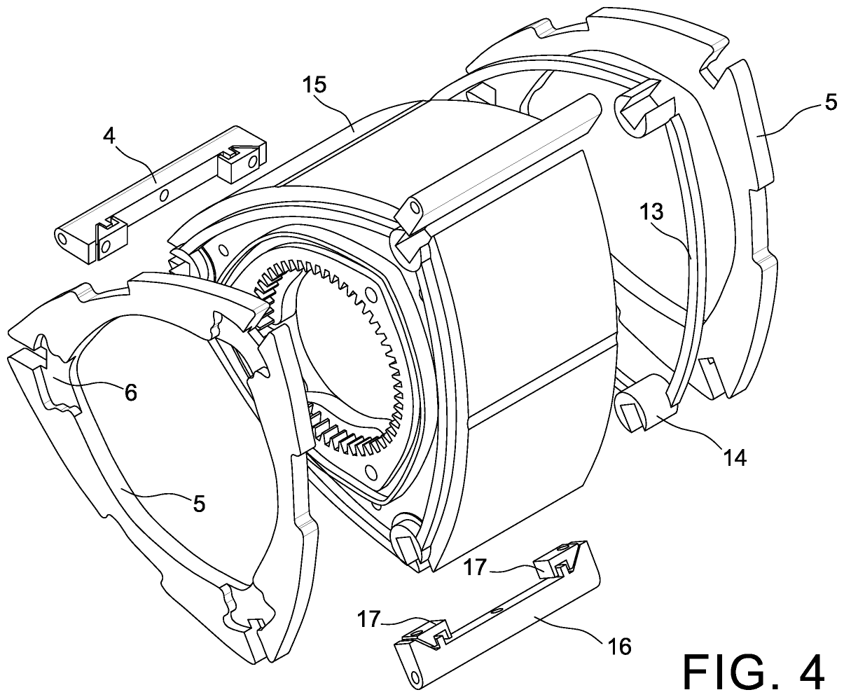

Referring to FIG. 4, it shows two rotor plates 5 each at outside of a rotor side ring 13 and a rotor corner seal 14. A passage 6 to crank case is provided on a tip of the rotor plate 5 so that a terminal end of an apex seal 4 keeps at a crank case pressure. Pressure of an apex seal bottom chamber 16 is relatively high. The pressure difference pushes two apex seal wedges 17 against the cylinder 3 at any rotor angles.

While the invention has been described in terms of preferred embodiments, those skilled in the art will recognize that the invention can be practiced with modifications within the spirit and scope of the appended claims.

What is claimed is:

1. A Wankel pump cycle residual boost system, comprising a plurality of cycle pump cavities on a cylinder wall wherein in a first group of the cycle pump cavities, a cycle residual boost to a next compression stroke is provided; and in a second group of the cycle pump cavities, a second release to an incoming intake stroke is provided.

2. The Wankel pump cycle residual boost system of claim 1, further comprising an apex seal active tracking mechanism including a low pressure passage on tips of rotor plates which allow apex seals to always stay in between of high pressure in a seal bottom chamber and a low pressure in a crank case; and a pressure difference between the high pressure and the low pressure forces seal wedges to push the apex seals to firmly contact the cylinder wall.
